(19) United States
(12) Patent Application Publication
(10) Pub. No.: US 2026/0080674 A1
(43) Pub. Date: Mar. 19, 2026

(54) ATTENTION-GUIDED ADVERSARIAL PATCH GENERATION METHOD FOR VISUAL TRACKING SECURITY DETECTION

(71) Applicant: HANGZHOU DIANZI UNIVERSITY, Hangzhou (CN)

(72) Inventors: Yuanfang CHEN, Hangzhou (CN); Xiaohan CHEN, Hangzhou (CN); Xing FANG, Hangzhou (CN); Sihang MA, Hangzhou (CN)

(21) Appl. No.: 19/396,325

(22) Filed: Nov. 20, 2025

(30) Foreign Application Priority Data
Feb. 18, 2025 (CN) 202510176405.9

(51) Int. Cl. G06V 10/82; G06V 10/25; G06V 10/774; G06V 10/776; G06V 20/40; G06V 20/58

(52) U.S. Cl. CPC G06V 10/82; G06V 10/25; G06V 10/774; G06V 10/776; G06V 20/46; G06V 20/58

(57) ABSTRACT

An attention-guided adversarial patch generation method for visual tracking security detection introduces attention-aware strategies and attention loss functions, and the adversarial patch generation is implemented through a TrackSpear model. The TrackSpear model includes two main modules: a sensitivity detection module and a patch attack module. The sensitivity detection module detects sensitive locations in target regions within video frames via an attention mechanism, thereby accurately locating key attack regions. The patch attack module generates and embeds adversarial patches, disrupting tracking performance of a target tracker by optimizing perturbations.

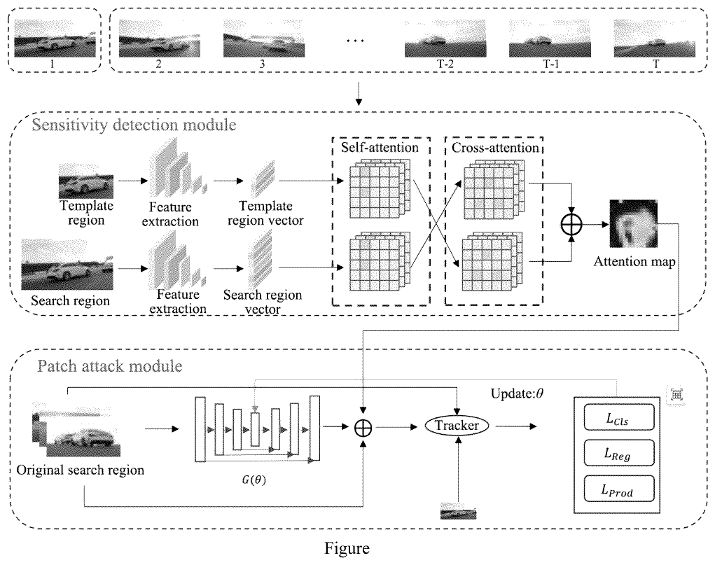

### CROSS-REFERENCE TO RELATED APPLICATIONS

This application claims the benefit of priority from Chinese Patent Application No. 202510176405.9, filed on Feb. 18, 2025. The content of the aforementioned application, including any intervening amendments made thereto, is incorporated herein by reference in its entirety.

### TECHNICAL FIELD

This application relates to autonomous driving and machine vision target tracking, and more particularly to an attention-guided adversarial patch generation method for visual tracking security detection.

### BACKGROUND

In autonomous driving traffic information systems, accurately tracking the movement of surrounding objects is crucial for ensuring the safety and reliability of autonomous vehicles. Visual target tracking, as a core task in computer vision, aims to locate and continuously track target objects in real time within dynamically changing video sequences, particularly in complex and rapidly evolving environments. With the rapid development of deep learning technologies, target tracking models based on Transformer architecture have demonstrated outstanding performance by using self-attention mechanisms in capturing long-range dependencies between objects and their surroundings. These target tracking models exhibit significant advantages, especially when handling dynamic and complex scenarios. However, deep neural networks, particularly visual tracking models, are susceptible to attacks by meticulously crafted adversarial samples. The emergence of physical adversarial attacks has made this threat increasingly feasible in real-world scenarios.

Existing adversarial attack methods predominantly rely on global perturbations. However, in practical applications, achieving such perturbations is challenging due to the high demands for physical feasibility and precision. In practice, attacks typically employ local patches to disrupt target tracking. However, current local perturbation attack methods exhibit poor effectiveness against visual tracking models based on Transformer architectures. Since Transformer models can capture global dependencies and possess relatively strong adversarial robustness, they generally resist small-scale perturbations, thereby making the design of effective physical adversarial patches more difficult. Consequently, developing attack methods targeting Transformer structures not only aids in deepening the understanding of their potential vulnerabilities but also provides a crucial research direction for further enhancing their defensive capabilities.

### SUMMARY

To address the deficiencies in the prior art, the present application proposes an attention-guided adversarial patch generation method for visual tracking security detection. This attention-guided adversarial patch generation method aims to resolve the problem of poor effectiveness exhibited by conventional local perturbation attack methods against visual tracking models based on Transformer architectures.

Specifically, the technical problems addressed include:

Threat of adversarial samples: with the proliferation of autonomous driving technology, visual target tracking systems face challenges from adversarial samples; meticulously crafted adversarial samples can deceive tracking models through local perturbations in real-world scenarios, leading to errors in target tracking and consequently compromising the safety and reliability of autonomous driving systems.

Lack of consideration for attention distribution and target characteristics in target trackers: different trackers focus on different locations, yet existing adversarial patches fail to adequately account for this, resulting in limited attack effectiveness and an inability to effectively perturb specific attention regions of the tracker.

Lack of consideration for the self-attention mechanism in Transformer models: transformer models capture global dependencies through their self-attention mechanism and possess relatively strong adversarial robustness; and existing research has not adequately considered how to design effective adversarial patches targeting this characteristic.

Technical solutions of the present application are described as follows.

This application provides an attention-guided adversarial patch generation method for visual tracking security detection, wherein adversarial patch generation is implemented through a TrackSpear model, and the TrackSpear model comprises two main modules: a sensitivity detection module and a patch attack module;
the sensitivity detection module is configured to detect sensitive locations in target regions of video frames via an attention mechanism, thereby locating a key attack region; and
the patch attack module is configured to generate and embed an adversarial patch, and disrupt tracking performance of a target tracker by optimizing perturbation;
the attention-guided adversarial patch generation method comprises:
(1) inputting a video sequence I={I₁, I₂, . . . , Iₜ} into the TrackSpear model for processing and analysis;
(2) analyzing, by the sensitivity detection module, the video frames frame-by-frame, and locating a key attack region p* based on an attention map Aₜ generated according to a tracker structure; and
(3) in the patch attack module, generating, by a perturbation generator G, an adversarial patch p=G(Iₜ) based on a video frame Iₜ, and embedding the adversarial patch p=G(Iₜ) into the key attack region p* in step (2), thereby generating an adversarial sample Iₜ*=Iₜ⊙(1−m)+p⊙m, wherein ⊙ denotes Hadamard product, and m is a mask matrix for controlling an embedding range of the adversarial patch p=G(Iₜ), thereby attacking target tracking;

In an embodiment, step (2) is performed through following steps:
depending on the tracker structure, generation of the attention map Aₜ and localization of the key attack region p* are categorized into following two approaches:
(2-1) a corner head-based approach comprising:
analyzing the attention map Aₜ and selecting a region with a highest attention; based on a center point of a template region as a reference, capturing relationships between different tokens in a search region, and generating an attention map

$${A}_{t} = \frac{{QK}^{T}}{\sqrt{{d}_{k}}}$$

from the search region to the template region, wherein Q represents a query vector in the search region, K represents a key vector in the template region, dₖ is a dimension of the key vector, serving as a scaling factor to ensure computational stability; based on the attention map

$${A}_{t} = \frac{{QK}^{T}}{\sqrt{{d}_{k}}} ,$$

calculating a patch placement location p*, ensuring a patch can be accurately embedded into a key target location in the search region;

(2-2) a center head-based approach comprising:
generating an attention map

$${A}_{t} = Softmax ( \frac{Q {K}^{T}}{\sqrt{{d}_{k}}} ) V ,$$

and selecting a position with a highest attention value as a patch placement point p*, wherein the attention map Aₜ in the center head-based approach directly reflects a center position of a target object, there is no need to reference a center point of a template region; and V is a value vector containing feature information associated with each position, configured for weighted generation of a final feature representation.

In an embodiment, a training process of the perturbation generator G in step (3) comprises:
(3-1) Dataset construction: collecting diverse video datasets, comprising a public dashcam dataset, an autonomous driving dataset, and vehicle driving video data obtained through actual collection; this ensures broad adaptability and strong generalization capabilities of the generated model, thereby enhancing its performance and reliability in complex scenarios.
(3-2) Model sequence input and initialization: extracting a video frame sequence {X₁, X₂, . . . , Xₜ} from constructed diverse video datasets as input for the perturbation generator G and its parameter φ during a training process;
(3-3) Adversarial patch generation: for each frame Xₜ, generating an adversarial patch pₜ via the perturbation generator G, which is represented by a formula:

$${p}_{t} = G ( {I}_{t} ; ϕ ) ;$$

subsequently, embedding the adversarial patch pₜ into a key attack region of the frame Xₜ to generate an adversarial sample

$${X}_{t}^{*} * ,$$

which is represented by a formula:

$${X}_{t}^{*} = {X}_{t} ⊙ ( 1 - m ) + {p}_{t} ⊙ m ,$$

wherein ⊙ denotes Hadamard product, and m is a mask matrix for controlling an embedding range of the adversarial patch pₜ;
(3-4) Loss function calculation: defining a total loss function as L=αL_{Prod}+βL_{Cls}+γL_{Reg}, wherein L_{Prod} is a dot-product loss for an attention mechanism, L_{Cls} is a classification loss, L_{Reg} is a regression loss, and coefficients α, β, and γ are configured to balance influence of each loss term; and
(3-5) Parameter update: updating the parameter φ of the perturbation generator G using an Adam optimizer, which is represented by a formula:

$$ϕ ← ϕ - η {∇}_{ϕ} L ;$$

wherein η is a learning rate; and
repeating steps (3-2) to (3-5) until the generator G converges or a maximum number of training iterations is reached.

In an embodiment, an algorithm for the dot-product loss L_{Prod} for the attention mechanism is represented as follows:

$${A}_{h} = \frac{{\overline{Q}}_{h} {\overline{K}}_{h}^{T}}{\sqrt{{d}_{k}}}$$

$$\overline{Q} = \frac{Q}{\frac{1}{n} {‖ Q ‖}_{1 , 2}} , \overline{K} = \frac{K}{\frac{1}{n} {‖ K ‖}_{1 , 2}}$$

$${‖ X ‖}_{1 , 2} = {\sum }_{i} \sqrt{{\sum }_{j} {X}_{ij}^{2}}$$

$${L}_{Prod} = - \frac{1}{{L}_{layers} {H}_{heads}} {\sum }_{l = 1}^{{L}_{layers}} {\sum }_{i = 1}^{{H}_{heads}} ( \frac{1}{n} {\sum }_{j = 1}^{n} {A}_{h} [ p , j ] )$$

wherein a matrix Aₕ represents an attention matrix of a self-attention layer l and an attention head h; a query matrix Q represents the query vector, and a key matrix K represents the key vector; to prevent gradient explosion or vanishing caused by large dot-product values, Q and K are normalized using ∥⋅∥_{1,2} norm to ensure gradient stability; wherein n represents a sequence length, and a matrix X represents the query vector Q or the key vector K; L_{layers} represents a total number of layers in a self-attention mechanism, and H_{heads} represents a number of attention heads per layer;
an image is divided into fixed-size patches before inputting into a Transformer model; each patch is embedded into a fixed-dimensional vector space via a linear mapping function ƒ; and a mapping between patches and tokens follows row-major order, traversing from left to right and top to bottom, thereby determining token indices based on patch positions;
in a target tracking task, attacks are implemented at three key positions: after the patches are added to the search region, the Transformer model first performs self-attention calculation, then applies cross-attention; in the self-attention layer, the attacks are launched from either the query matrix Q or the key matrix K; when attacking from a query side, the Transformer model directs more attention on the patch positions, amplifying patch impact on target features and disrupting target detection; when attacking from a key side, the key vector is perturbed, affecting key-value mapping, amplifying patch attraction to other regions, and altering self-attention distribution; and
in a cross-attention layer, the attacks enhance similarity between the patches and the template region by misleading the Transformer model, erroneously identifying a patch as a target; and a loss function L_{Prod} in the algorithm further enhances an adversarial effect by implementing attacks on the key side within the search region.

In an embodiment, an algorithm for the classification loss L_{Cls} is represented as follows:

$${L}_{C l s} ( {P}_{t}^{a} , {P}_{t}^{h} , {C}_{t}^{a} ) = \frac{1}{H} {\sum }_{H > δ} ( B C E ( {P}_{t}^{a} [ H ] , 0 ) + λQ )$$

$$Q = {C}_{t}^{a} [ H ] [ : 0 ] - {C}_{t}^{a} [ H ] [ : 1 ]$$

wherein

$${P}_{t}^{a}$$

is a probability feature map generated by the target tracker from an original sample at a frame t;

$${P}_{t}^{h} and {C}_{t}^{a}$$

represent a probability feature map and a classification feature map generated by a transfer tracker for the adversarial sample at the frame t, respectively; H represents an input feature region where a confidence exceeds a confidence threshold δ; λ is a weight coefficient, and Q is an additional constraint term introduced to adjust performance of an overall loss function; and
a loss function L_{Cls} uses binary cross-entropy to measure a difference between regions with confidence higher than δ, namely

$${P}_{t}^{a}$$

and zero, encouraging values of high-confidence regions to converge toward zero; simultaneously, by adding the constraint term Q, a difference between foreground and background scores in the high-confidence regions is minimized, which constraint forces the Transformer model to struggle in distinguishing between foreground and background, thereby interfering with model decision-making and increasing vulnerability to adversarial perturbations.

In an embodiment, an algorithm for the regression loss L_{Reg} is represented as follows:

$${L}_{R e g} ( {R}_{t}^{h} , {R}_{t}^{a} , {P}_{t}^{h} ) = \frac{1}{H} {\sum }_{H > δ} GIOU ( b b o {x}_{gt} , bbo {x}_{p r e d} [ H ] ) ;$$

wherein

$${R}_{t}^{h}$$

represents a regression feature map generated by a transfer tracker for an original sample at a frame t, and Rₜ^{a} represent a regression feature map generated by the transfer tracker for an adversarial sample at the frame t; bbox_{gt} represents a predicted bounding box generated by a transmission tracker for the adversarial sample, and bbox_{pred}[H] represents a predicted bounding box generated by the transmission tracker for the original sample; in a tracking process, a low IoU value between a predicted box and a ground truth box indicates that the predicted box is unsuitable as a final tracking result; compared to IoU, even if the predicted box completely deviates from a real target, GIoU still measures an offset between the predicted box and the real target; and the GIoU value gradually increases as a relative distance between the predicted box and the real target increases, which guides predictions of the target tracker away from a position of the real target; and
to interrupt the tracking process, a bounding box in a bbox_{gt} region with confidence higher than δ are first selected, and a GIoU value at the position of the real target is calculated using bbox_{pred}[H], thereby causing a selected predicted box to deviate from the position of the real target and reducing a width and height of the selected predicted box, resulting in that the search region in a next frame no longer contains the position of the real target, thereby degrading a performance of the target tracker.

Compared to the prior art, the present disclosure has the following beneficial effects.

The present disclosure effectively enhances the adversarial attack capability against Transformer-based target trackers by introducing attention-aware strategies and attention loss functions, thereby precisely disrupting the stability of the target tracking system. Furthermore, the present disclosure significantly increases the threat level to Transformer-based visual tracking models and heightens their sensitivity to potential attacks.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The FIGURE is an algorithm flowchart of an attention-guided adversarial patch generation method for visual tracking security detection according to an embodiment of the present disclosure.

### DETAILED DESCRIPTION OF EMBODIMENTS

The disclosure will be further described in detail below with reference to the embodiments and accompanying drawings. It should be understood that the embodiments described herein are only used to illustrate the technical solutions of the present disclosure more clearly, and not intended to limit the disclosure.

FIGURE shows an attention-guided adversarial patch generation method for visual tracking security detection. The adversarial patch generation is implemented through a TrackSpear model. The model includes two main modules: a sensitivity detection module and a patch attack module.

The sensitivity detection module detects sensitive locations in target regions within video frames via an attention mechanism, thereby accurately locating key attack regions.

The patch attack module generates and embeds adversarial patches, disrupting the tracking performance of a target tracker by optimizing perturbations.

The specific steps are as follows.
(1) A video sequence I={I₁, I₂, . . . , Iₜ} is input into the TrackSpear model for processing and analysis.
(2) The sensitivity detection module analyzes the video frames frame-by-frame and accurately locates a key attack region p* based on an attention map Aₜ generated according to a tracker structure.
(3) In the patch attack module, a perturbation generator G generates a specific adversarial patch p=G(Iₜ) based on a video frame Iₜ, and embeds the specific adversarial patch p=G(Iₜ) into the key attack region p* in step (2), thereby generating an adversarial sample

$${I}_{t}^{*} = {I}_{t} ⊙ ( 1 - m ) + p ⊙ m ,$$

where ⊙ denotes the Hadamard product, and m is a mask matrix for controlling an embedding range of the specific adversarial patch p=G(Iₜ), thereby achieving effective attacks on target tracking. The adversarial patch p above is a generic adversarial patch, which appears as a general description and is not specifically associated with any particular time or frame.

Preferably, the specific steps of the aforementioned step (2) are as follows.

Depending on the tracker structure, the generation of the attention map and the localization of the key attack region are divided into the following two approaches.
(2-1) Corner Head-based approach

The attention map is analyzed to select a region with the highest attention. Based on a center point of a template region as a reference, relationships between different tokens in a search region are captured, generating an attention map

$${A}_{t} = \frac{{QK}^{T}}{\sqrt{{d}_{k}}}$$

from the search region to the template region. Q represents a query vector in the search region, K represents a key vector in the template region, and dₖ is a dimensionality of the key vector, serving as a scaling factor to ensure computational stability. Based on the computed attention map, a patch placement location p* is calculated, ensuring the patch can be accurately embedded into a key target location in the search region.

The term “region with the highest attention” mentioned above refers to selecting the position with the maximum attention value based on the attention values assigned to each region in the generated attention map Aₜ. This maximum attention value is relative, indicating the region possessing the highest attention relative to other regions within the current video frame or image. The specific numerical value of the attention is a relative value obtained through computation. Specifically, the maximum attention value represents the highest attention degree that the model places on a particular region during the self-attention computation. This attention is derived by calculating the inner product of the query (Q) and key (K) vectors. Consequently, the specific attention value is not fixed but varies depending on the model and the input data.
(2-2) Center Head-based approach

An attention map

$${A}_{t} = Softmax ( \frac{{QK}^{T}}{\sqrt{{d}_{k}}} ) V$$

is generated, and a position with the highest attention value is selected as the patch placement point p*. Since the attention map in the center head-based approach directly reflects a center position of the target object, there is no need to reference the center point of the template region. V is a value vector, containing feature information associated with each position, and is used for weighted generation of a final feature representation.

The patch placement point p* refers to, in the center head-based approach, selecting the region with the highest attention via the generated attention map Aₜ. This denotes that in the object tracking task, the selection for patch location is determined based on the high attention value of the target's position within the attention map. In contrast, the key attack region is a region determined through the model analysis during the adversarial attack, typically referring to the specific region where the adversarial patch is embedded. Consequently, the patch placement point is primarily a specific point selected for embedding the attack patch, whereas the key attack region describes the target area as a whole.

In an embodiment, the specific training process for the perturbation generator G in step (3) is as follows:
(3-1) Dataset construction: diverse video datasets are collected, including public dashcam datasets, autonomous driving datasets, and vehicle driving video data obtained through actual collection. This ensures broad adaptability and strong generalization capabilities of the generated model, thereby enhancing its performance and reliability in complex scenarios.
(3-2) Model sequence input and initialization: a video frame sequence {X₁, X₂, . . . , Xₜ} is extracted from constructed diverse video datasets as input for the perturbation generator G and its parameter φ during a training process.
(3-3) Adversarial patch generation: for each frame Xₜ, an adversarial patch pₜ is generated via the perturbation generator G, which is represented by a formula: pₜ=G(lₜ; φ); subsequently, the adversarial patch pₜ is embed into a key attack region of the frame Xₜ to generate an adversarial sample

$${X}_{t}^{*} * ,$$

which is represented by a formula:

$${X}_{t}^{*} = {X}_{t} ⊙ ( 1 - m ) + {p}_{t} ⊙ m ,$$

where ⊙ denotes the Hadamard product, and m is the mask matrix for controlling an embedding range of the adversarial patch pₜ. The adversarial patch pₜ described here refers to a specific adversarial patch generated for each frame Xₜ by the perturbation generator G. This patch is generated on a per-frame basis, indicating that it is dynamic and time-dependent, meaning that pₜ may differ for each frame.
(3-4) Loss function calculation: a total loss function is defined as L=αL_{Prod}+βL_{Cls}+γL_{Reg}, where L_{Prod} is a dot-product loss for an attention mechanism, L_{Cls} is a classification loss, L_{Reg} is a regression loss, and coefficients α, β, and γ are used to balance influence of each loss term.
(3-5) Parameter update: the parameter φ of the perturbation generator G is updated using an Adam optimizer, which is represented by a formula: φ←φ−η∇_{φ}L, where η is a learning rate; and steps (3-2) to (3-5) are repeated until the generator G converges or a maximum number of training iterations is reached.

In an embodiment, the specific algorithm for the dot-product loss L_{Prod} targeting the attention mechanism is represented as follows:

$${A}_{h} = \frac{{\overline{Q}}_{h} {\overline{K}}_{h}^{T}}{\sqrt{{d}_{k}}}$$

$$\overline{Q} = \frac{Q}{\frac{1}{n} {‖ Q ‖}_{1 , 2}} , \overline{K} = \frac{K}{\frac{1}{n} {‖ K ‖}_{1 , 2}}$$

$${‖ X ‖}_{1 , 2} = {\sum }_{i} \sqrt{{\sum }_{j} {X}_{ij}^{2}}$$

$${L}_{Prod} = - \frac{1}{{L}_{layers} {H}_{heads}} {\sum }_{l = 1}^{{L}_{layers}} {\sum }_{i = 1}^{{H}_{heads}} ( \frac{1}{n} {\sum }_{j = 1}^{n} {A}_{h} [ p , j ] ) .$$

In formulas above, a matrix Aₕ represents an attention matrix of a self-attention layer l and an attention head h; a query matrix Q represents the query vector, and a key matrix K represents the key vector; to prevent gradient explosion or vanishing caused by large dot-product values, Q and K are normalized using ∥⋅∥_{1,2} norm to ensure gradient stability. Here, n represents a sequence length, and a matrix X represents the query vector Q or the key vector K; L_{layers} represents a total number of layers in a self-attention mechanism, and H_{heads} represents a number of attention heads per layer.

Before inputting into the Transformer model, images are divided into fixed-size patches. Each patch is embedded into a fixed-dimensional vector space via a linear mapping function ƒ. The mapping between patches and tokens follows row-major order, traversing from left to right and top to bottom, thereby determining token indices based on patch positions.

In target tracking tasks, attacks are executed at three key positions. After the patches are added to the search region, the model first performs self-attention calculation, then applies cross-attention. In the self-attention layer, the attacks can originate from either the query matrix Q or the key matrix K. When attacking from the query side, the model directs more attention on the patch position, amplifying the patch impact on target features and disrupting target detection. When attacking from a key side, the key vector is perturbed, affecting key-value mapping, amplifying patch attractiveness to other regions, and altering self-attention distribution.

In the cross-attention layer, the attacks increase similarity between the patches and the template region by misleading the model, erroneously identifying patches as a target. The loss function L_{Prod} in the algorithm further enhances adversarial effects by implementing attacks on the key side within the search region.

In an embodiment, the specific algorithm for the aforementioned classification loss L_{Cls} is represented as follows:

$${L}_{Cls} ( {P}_{t}^{a} , {P}_{t}^{h} , {C}_{t}^{a} ) = \frac{1}{H} {\sum }_{H > δ} ( BCE ( {P}_{t}^{a} [ H ] , 0 ) + λ Q )$$

$$Q = {C}_{t}^{a} [ H ] [ : 0 ] - {C}_{t}^{a} [ H ] [ : 1 ] .$$

In formulas above,

$${P}_{t}^{a}$$

is a probability feature map generated by the target tracker for the original sample at a frame t;

$${P}_{t}^{h} and {C}_{t}^{a}$$

represent a probability feature map and a classification feature map generated by a transfer tracker for the adversarial sample at the frame t, respectively; H represents an input feature region where a confidence exceeds a confidence threshold δ; λ is a weight coefficient, and Q is an additional constraint term introduced to adjust performance of an overall loss function.

The loss function L_{Cls} uses binary cross-entropy to measure the difference between regions with confidence higher than δ, namely

$${P}_{t}^{a}$$

and zero, encouraging values in high-confidence regions to converge toward zero. Simultaneously, by adding the constraint term Q, the difference between foreground and background scores in the high-confidence regions is minimized, which constraint forces the Transformer model to struggle in distinguishing the foreground from background, thereby interfering with model decision-making and increasing vulnerability to adversarial perturbations.

In an embodiment, the specific algorithm for the regression loss L_{Reg} is represented as follows.

$${L}_{reg} ( {R}_{t}^{h} , {R}_{t}^{a} , {R}_{t}^{h} ) = \frac{1}{H} {\sum }_{H > δ} GIOU ( {bbox}_{gt} , {bbox}_{pred} [ H ] ) .$$

In formulas above, wherein

$${R}_{t}^{h}$$

represents a regression feature map generated by a transfer tracker for an original sample at the frame t, and

$${R}_{t}^{a}$$

represent a regression feature map generated by a transfer tracker for the adversarial sample at the frame t; bbox_{gt} represents a predicted bounding box generated by a transmission tracker m for the adversarial sample, and bbox_{pred}[H] represents a predicted bounding box generated by a transmission tracker m for the original sample. In the tracking process, a low IoU value between a predicted box and a ground truth box typically indicates that the predicted box is unsuitable as the final tracking result. Compared to IoU, GIoU offers a more significant improvement. Even if the predicted box completely deviates from the real target, GIoU effectively measures the offset between the predicted box and the real target. The GIoU value gradually increases as the relative distance between the predicted box and the real target increases, which helps guide predictions of the target tracker away from the position of the real target.

To interrupt the tracking process, the bounding box in the bbox_{gt} region with confidence higher than threshold & are first selected, and GIoU values at the position of the real target are calculated using bbox_{pred}[H], thereby causing the selected predicted box to deviate from the position of the real target and reducing the width and height of the selected predicted box, resulting in that the search region in a next frame no longer contains the position of the real target, thereby degrading a performance of the target tracker.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. An attention-guided adversarial patch generation method for visual tracking security detection, wherein adversarial patch generation is implemented through a TrackSpear model, and the TrackSpear model comprises a sensitivity detection module and a patch attack module;
the sensitivity detection module is configured to detect sensitive locations in target regions of video frames via an attention mechanism, thereby locating a key attack region; and
the patch attack module is configured to generate and embed an adversarial patch, and disrupt tracking performance of a target tracker by optimizing perturbation;
the attention-guided adversarial patch generation method comprises:
(1) inputting a video sequence I={I₁, I₂, . . . , Iₜ} into the TrackSpear model for processing and analysis;
(2) analyzing, by the sensitivity detection module, the video frames frame-by-frame, and locating a key attack region p* based on an attention map Aₜ generated according to a tracker structure; and
(3) in the patch attack module, generating, by a perturbation generator G, an adversarial patch p=G(Iₜ) based on a video frame Iₜ, and embedding the adversarial patch p=G(Iₜ) into the key attack region p* in step (2), thereby generating an adversarial sample
$${I}_{t}^{*} = {I}_{t} ⊙ ( 1 - m ) + p ⊙ m ,$$
wherein ⊙ denotes Hadamard product, and m is a mask matrix for controlling an embedding range of the adversarial patch p=G(Iₜ), thereby attacking target tracking;
wherein step (2) is performed through following steps:
depending on the tracker structure, generation of the attention map Aₜ and localization of the key attack region p* are categorized into following two approaches:
(2-1) a corner head-based approach comprising:
analyzing the attention map Aₜ and selecting a region with a highest attention; based on a center point of a template region as a reference, capturing relationships between different tokens in a search region, and generating the attention map
$${A}_{t} = \frac{{QK}^{T}}{\sqrt{{d}_{k}}}$$
from the search region to the template region, wherein Q represents a query vector in the search region, K represents a key vector in the template region, dₖ is a dimension of the key vector, serving as a scaling factor to ensure computational stability; based on the attention map
$${A}_{t} = \frac{{QK}^{T}}{\sqrt{{d}_{k}}} ,$$
calculating a patch placement location p*, ensuring a patch being embedded into a key target location in the search region;
(2-2) a center head-based approach comprising:
generating an attention map
$${A}_{t} = S o f t m a x ( \frac{Q {K}^{T}}{\sqrt{{d}_{k}}} ) V ,$$
and selecting a position with a highest attention value as a patch placement point p*, wherein the attention map Aₜ in the center head-based approach directly reflects a center position of a target object, there is no need to reference a center point of a template region; and V is a value vector containing feature information associated with each position, configured for weighted generation of a final feature representation.

2. The attention-guided adversarial patch generation method of claim 1, wherein a training process of the perturbation generator G in step (3) comprises:
(3-1) collecting diverse video datasets, comprising a public dashcam dataset, an autonomous driving dataset, and vehicle driving video data obtained through actual collection;
(3-2) extracting a video frame sequence {X₁, X₂, . . . , Xₜ} from constructed diverse video datasets as input for the perturbation generator G and its parameter ¢ during a training process;
(3-3) for each frame Xₜ, generating an adversarial patch pₜ via the perturbation generator G, which is represented by a formula:
$${p}_{t} = G ( {I}_{t} ; ϕ ) ;$$
subsequently, embedding the adversarial patch pₜ into a key attack region of the frame Xₜ to generate an adversarial sample
$${X}_{t}^{*} * ,$$
which is represented by a formula:
$${X}_{t}^{*} = {X}_{t} ⊙ ( 1 - m ) + {p}_{t} ⊙ m ,$$
wherein ⊙ denotes Hadamard product, and m is a mask matrix for controlling an embedding range of the adversarial patch pₜ;
(3-4) defining a total loss function as L=αL_{Prod}+βL_{Cls}+γL_{Reg}, wherein L_{Prod} is a dot-product loss for an attention mechanism, L_{Cls} is a classification loss, L_{Reg} is a regression loss, and coefficients α, β, and γ are configured to balance influence of each loss term; and
(3-5) updating the parameter φ of the perturbation generator G using an Adam optimizer, which is represented by a formula:
$$ϕ ← ϕ - η {∇}_{ϕ} L ;$$
wherein η is a learning rate; and
repeating steps (3-2) to (3-5) until the generator G converges or a maximum number of training iterations is reached.

3. The attention-guided adversarial patch generation method of claim 2, wherein an algorithm for the dot-product loss L_{Prod} for the attention mechanism is represented as follows:
$${A}_{h} = \frac{{\overline{Q}}_{h} {\overline{K}}_{h}^{T}}{\sqrt{{d}_{k}}}$$
$$\overline{Q} = \frac{Q}{\frac{1}{n} {‖ Q ‖}_{1 , 2}} , \overline{K} = \frac{K}{\frac{1}{n} {‖ K ‖}_{1 , 2}}$$
$${‖ X ‖}_{1 , 2} = {\sum }_{i} \sqrt{{\sum }_{j} {X}_{i j}^{2}}$$
$${L}_{P r o d} = - \frac{1}{{L}_{l a y e r s} {H}_{h e a d s}} {\sum }_{l = 1}^{{L}_{l a y e r s}} {\sum }_{i = 1}^{{H}_{h e a d s}} ( \frac{1}{n} {\sum }_{j = 1}^{n} {A}_{h} [ p , j ] )$$
wherein a matrix Aₕ represents an attention matrix of a self-attention layer l and an attention head h; a query matrix Q represents the query vector, and a key matrix K represents the key vector; to prevent gradient explosion or vanishing caused by large dot-product values, Q and K are normalized using ∥⋅∥_{1,2} norm to ensure gradient stability; wherein n represents a sequence length, and a matrix X represents the query vector Q or the key vector K; L_{layers} represents a total number of layers in a self-attention mechanism, and H_{heads} represents a number of attention heads per layer;
an image is divided into fixed-size patches before inputting into a Transformer model; each patch is embedded into a fixed-dimensional vector space via a linear mapping function ƒ; and a mapping between patches and tokens follows row-major order, traversing from left to right and top to bottom, thereby determining token indices based on patch positions;
in a target tracking task, attacks are implemented at three key positions: after the patches are added to the search region, the Transformer model first performs self-attention calculation, then applies cross-attention; in the self-attention layer, the attacks are launched from either the query matrix Q or the key matrix K; when attacking from a query side, the Transformer model directs more attention on the patch positions, amplifying patch impact on target features and disrupting target detection; when attacking from a key side, the key vector is perturbed, affecting key-value mapping, amplifying patch attraction to other regions, and altering self-attention distribution; and
in a cross-attention layer, the attacks enhance similarity between the patches and the template region by misleading the Transformer model, erroneously identifying a patch as a target; and a loss function L_{Prod} in the algorithm further enhances an adversarial effect by implementing attacks on the key side within the search region.

4. The attention-guided adversarial patch generation method of claim 2, wherein an algorithm for the classification loss L_{Cls} is represented as follows:
$${L}_{C l s} ( {P}_{t}^{a} , {P}_{t}^{h} , {C}_{t}^{a} ) = \frac{1}{H} {\sum }_{H > δ} ( B C E ( {P}_{t}^{a} [ H ] , 0 ) + λQ )$$
$$Q = {C}_{t}^{a} [ H ] [ : 0 ] - {C}_{t}^{a} [ H ] [ : 1 ]$$
wherein
$${P}_{t}^{a}$$
is a probability feature map generated by the target tracker from an original sample at a frame t;
$${P}_{t}^{h} and {C}_{t}^{a}$$
represent a probability feature map and a classification feature map generated by a transfer tracker for the adversarial sample at the frame t, respectively; H represents an input feature region where a confidence exceeds a confidence threshold δ; λ is a weight coefficient, and Q is an additional constraint term introduced to adjust performance of an overall loss function; and
a loss function L_{Cls} uses binary cross-entropy to measure a difference between regions with confidence higher than δ, namely
$${P}_{t}^{a}$$
and zero, encouraging values of high-confidence regions to converge toward zero; simultaneously, by adding the constraint term Q, a difference between foreground and background scores in the high-confidence regions is minimized, which constraint forces the Transformer model to struggle in distinguishing between foreground and background, thereby interfering with model decision-making and increasing vulnerability to adversarial perturbations.

5. The attention-guided adversarial patch generation method of claim 2, wherein an algorithm for the regression loss L_{Reg} is represented as follows:
$${L}_{R e g} ( {R}_{t}^{h} , {R}_{t}^{a} , {P}_{t}^{h} ) = \frac{1}{H} {\sum }_{H > δ} GIOU ( b b o {x}_{gt} , b b o {x}_{p r e d} [ H ] ) ;$$
wherein
$${R}_{t}^{h}$$
represents a regression feature map generated by a transfer tracker for an original sample at a frame t, and
$${R}_{t}^{a}$$
represent a regression feature map generated by the transfer tracker for an adversarial sample at the frame t; bbox_{gt} represents a predicted bounding box generated by a transmission tracker for the adversarial sample, and bbox_{pred}[H] represents a predicted bounding box generated by the transmission tracker for the original sample; in a tracking process, a low IoU value between a predicted box and a ground truth box indicates that the predicted box is unsuitable as a final tracking result; compared to IoU, even if the predicted box completely deviates from a real target, GIoU still measures an offset between the predicted box and the real target; and the GIoU value gradually increases as a relative distance between the predicted box and the real target increases, which guides predictions of the target tracker away from a position of the real target; and
to interrupt the tracking process, a bounding box in a bbox_{gt} region with confidence higher than δ are first selected, and a GIoU value at the position of the real target is calculated using bbox_{pred}[H], thereby causing a selected predicted box to deviate from the position of the real target and reducing a width and height of the selected predicted box, resulting in that the search region in a next frame no longer contains the position of the real target, thereby degrading a performance of the target tracker.
